(19) United States
(12) Patent Application Publication
(10) Pub. No.: US 2017/0049134 A1
(43) Pub. Date: Feb. 23, 2017

(54) MEAT TENDERING USING FOOD GRADE NATURAL PRODUCTS FOR REDUCING MUSCLE CONTRACTION

(71) Applicant: Empire Technology Development LLC, Wilmington, DE (US)

(72) Inventor: Georgius Abidal Adam, Edensor Park (AU)

(21) Appl. No.: 14/829,539

(22) Filed: Aug. 18, 2015

(51) Int. Cl. A23L 1/318

(52) U.S. Cl. CPC A23L 1/3182; A23L 1/31445; A23L 1/3103; A23V 2002/00

(57) ABSTRACT

Compositions and methods that enhance tenderness in meat by reducing muscle contraction and rigor mortis following slaughter are disclosed. The compositions are natural products, including organic acids and polyphenols derived from natural sources, and derivatives and salts thereof.

### BACKGROUND

Meat is a desired process in meat technology because a carcass of beef undergoes rigor mortis, during which process muscles in the carcass naturally contract, thereby resulting in increased meat toughness.

Providing effective solutions to improve the production of tender meat has value across the meat supply chain, including livestock farmers, producers, abattoirs, meat packagers, providers of transport and logistics (local and international deliveries), government (through improved importing/exporting conditions), retailers, food service providers, and consumers. Ensuring meat tenderness is of great importance, as, for the consumer, the muscle fibers of meat that is not tender are difficult to chew making the eating experience less than pleasurable. This is a loss in potential value to many stakeholders.

Meat tenderizing can require chilling and storage while aging in order to maintain food safety and meat tenderness. Chilling and storage are costly in terms of time, resources, energy, and inventory management, all of which increase expenses.

There are several high cost technologies currently implemented such as aging the meat after slaughtering for several hours in which during this process, the enzymes within the meat break down the physical structure of the muscle which becomes tender. This process is controlled via the change of pH from 7 to 5.4 at a controlled temperature gradient. Aging however is highly costly and time consuming. As such, an enhanced and economic process for meat tenderizing is much desired.

### SUMMARY

A composition is disclosed for tenderizing meat. The composition includes at least one of an organic acid including derivatives and salts thereof, a polyphenol including derivatives and salts thereof, or both an organic acid and a polyphenol and derivatives and salts thereof, wherein the organic acid and the polyphenol are derived from natural plant or animal sources. The composition also includes at least one additive. The composition may be a powder or a liquid. The liquid composition may have a pH of about 5.0 to about 7.0.

The organic acid including derivatives and salts thereof may be selected from fulvic acid, humic acid, citric acid, malic acid or gallic acid. The organic acid including derivatives and salts thereof may make up from about 1% to about 10% (w/w) of the composition as a powder or from about 1% to about 10% (w/w) of the composition as a liquid.

The at least one additive may be selected from ρ-coumaric acid, tyrosol, hydroxytyrosol, vanillic acid, siringic acid, caffeic acid, ferulic acid, sinapic acid, cinnamic acid, dihydroferulic acid, oleuropein, ellagic acid, glansrin, tannic acid, and/or taxifolin, and may make up from about 1% to about 10% (w/w) of the composition as a powder or from about 1% to about 10% (w/w) of the composition as a liquid.

In one variation, the composition may also include sodium carbonate, wherein the sodium carbonate may make up from about 1% to about 10% (w/w) of the composition as a powder or from about 1% to about 10% (w/w) of the composition as a liquid.

In another variation, the composition may also include sodium tri-polyphosphate, wherein the sodium tri-polyphosphate may make up from about 1% to about 10% (w/w) of the composition as a powder or from about 1% to about 10% (w/w) of the composition as a liquid.

In another variation, the composition may also include at least one vitamin.

In another variation, the composition may also include at least spice, wherein the at least one spice may make up from about 1% to about 10% (w/w) of the composition as a powder or from about 1% to about 10% (w/w) of the composition as a liquid.

In another variation, the composition may also include lignin or a lignin derivative, wherein the lignin or a lignin derivative may make up from about 1% to about 10% (w/w) of the composition as a powder or from about 1% to about 10% (w/w) of the composition as a liquid. The lignin derivative may be obtained by lignin cleavage by thermal decomposition, thermooxidative decomposition or catalytic cleavage.

A method for tenderizing meat is also disclosed. The method includes contacting the meat with a composition for tenderizing meat under conditions sufficient to tenderize the meat. The composition may be a powder or a liquid, which makes up from about 1% to about 10% (w/w) of the composition as a powder or from about 1% to about 10% (w/w) of the composition as a liquid. The composition includes at least one of an organic acid including derivatives and salts thereof, or a polyphenol including derivatives and salts thereof, or both an organic acid and a polyphenol and derivatives and salts thereof, wherein the organic acid and the polyphenol are derived from natural plant or animal sources. The composition further includes at least one additive, selected from ρ-coumaric acid, tyrosol, hydroxytyrosol, vanillic acid, siringic acid, caffeic acid, ferulic acid, sinapic acid, cinnamic acid, dihydroferulic acid, oleuropein, ellagic acid, glansrin, tannic acid, or taxifolin.

The step of contacting the meat may include coating a surface of the meat with the composition. The total surface of the meat may be substantially coated with the composition. In another variation, the step of contacting the meat may include injecting the meat with a liquid form of the composition. The amount injected may make up at least about 1% to about 2% (v/w) of the meat. In another variation, the step of contacting the meat may include immersing the meat in the composition, wherein the composition is a liquid.

The step of contacting may be performed for about 5, 6, 7, 8, 9, 10, 11, 12, 13, 14, 15, 16, 17, 18, 19, 20, 21, 22, 23, 24, 25. 26, 27, 28, 29 or 30 minutes, or any other time period in the range defined by any two of these values. The step of contacting may be performed at 5° C., 6° C., 7° C., 8° C., 9° C., or 10° C., or any other temperature in the range defined by any two of these values.

In another variation, the step of contacting the meat may include injecting or feeding the composition to an animal before slaughter.

In one embodiment, the amount of composition, in liquid form, used in the step of contacting may be about 1 gallon per about 2 to about 4 kg of meat.

A tenderized meat product is disclosed in another embodiment. The meat may be selected from lamb, beef, poultry and pork. The tenderized meat product includes a composition, comprising about 1% to about 10% by weight of at least one an organic acid including derivatives and salts thereof, or a polyphenol including derivatives and salts thereof, or both an organic acid and a polyphenol and derivatives and salts thereof, wherein the organic acid and the polyphenol are derived from natural plant or animal sources. The composition also includes at least one additive selected from ρ-coumaric acid, Tyrosol, hydroxytyrosol, vanillic acid, siringic acid, caffeic acid, ferulic acid, sinapic acid, cinnamic acid, dihydroferulic acid, oleuropein, ellagic acid, glansrin, tannic acid, and taxifolin.

### BRIEF DESCRIPTION OF THE DRAWINGS

FIG. 1 shows a representative diagram showing muscle contraction mechanism via myosin calcium binding sites. As shown in panel A, when intracellular calcium is low (<10⁻⁸ M), tropomyosin blocks all actin site along one turn of the actin helix. As shown in panel B, when intracellular calcium is elevated (>10⁻⁷M), calcium binds to troponin which then alters the position of tropomyosin on the actin filament. Once tropomyosin has moved, the actin sites are exposed allowing myosin heads to attach.

FIG. 2 show a reaction scheme showing the mechanism of meat tenderizing via replacement of the bivalent ions (Ca²⁺ and Mg²⁺) with sodium ions or H⁺ via fulvic acids, its salts and cleaved products.

FIG. 3 shows lignin products from cleavage.

FIG. 4 shows lignin products from thermo-oxidative degradation of lignin.

### DETAILED DESCRIPTION

### Definitions

All patents, applications, published applications and other publications referred to herein are incorporated by reference for the referenced material and in their entireties. If a term or phrase is used herein in a way that is contrary to or otherwise inconsistent with a definition set forth in the patents, applications, published applications and other publications that are herein incorporated by reference, the use herein prevails over the definition that is incorporated herein by reference.

As used herein, the singular forms “a”, “an”, and “the” include plural references unless indicated otherwise, expressly or by context.

“Tenderizing” “tendering” or “tenderize” can refer to a process to break down meat to make it tender, and can include processes to break down proteins, such as collagens, for example, in to make it more palatable for consumption. The terms “meat tenderizing” and “meat tendering” can be used interchangeably. Meat tenderizing can be performed by the addition of a composition to break down the meat, mechanical tenderization, such as pounding or piercing, cooking, and/or braising. Tenderizing can also be performed by the addition of naturally occurring enzymes, which can be added to food before cooking. Examples of enzymes used for tenderizing can include by are not limited to papain from papaya, bromelain from pineapple and actinidin from kiwifruit. Meat tenderizing can also be performed by marinating the meat with a composition comprising enzymes, vinegar, wine, lemon juice, buttermilk and/or yogurt. Brining the meat in a salt solution and dry aging the meat at 0 to 2° C. can also be performed to tenderize the meat. In some embodiments, a method of tenderizing meat is provided. In the broadest sense, the method can comprise contacting said meat with a composition for tenderizing meat under conditions such that the meat is tenderized, wherein the said composition is a powder or a liquid, and comprises a 1-10% w/w as a powder or a 1-10% w/v as a liquid, of at least one of fulvic acid, humic acid, citric acid, malic acid, gallic acid, and/or polyphenols from natural sources, wherein the natural sources comprises di- and tri-carboxylic acids, phenolic derivatives, and their sodium salts, and further comprises at least one additive.

“Natural products” or “natural sources” as described herein, are products or sources that are naturally occurring and can include plants, plant parts, fruits, vegetables, and organisms. In some embodiments, described herein, the substances extracted from natural sources or products are capable of replacing alkaline earth metal ions. Without being limiting, examples of natural products or natural sources for replacing alkaline earth metal ions can include fulvic acid and its cleaved product with sodium salts, humic acid and its cleaved products with sodium salts, citric acid and its sodium salts, malic acid and its sodium salts, gallic acid and its sodium salts and other natural sources consisting di and tri carboxylic acids and their sodium salts that can replace alkaline earth metal ions. In some embodiments described herein, the natural sources are from plants or animals as a synthesized product or a breakdown product. Without being limiting, natural sources can be derived from plant material (for example, barley grain, flaxseed, Angelica sinensis) such as roots, leaves, and cell walls, as a products from the microbial degradation of dead plant matter, such as lignin, substances produced by biodegradation of dead organic matter, fruits (for example, olives, and vegetables (for example, tomatoes, carrots, and garlic),

Humic acid is a principal component of humic substances, which are the major organic constituents of soil (humus), peat, coal, many upland streams, dystrophic lakes, and ocean water. It is produced by biodegradation of dead organic matter. It is not a single acid; rather, it is a complex mixture of many different acids containing carboxyl and phenolate groups so that the mixture behaves functionally as a dibasic acid or, occasionally, as a tribasic acid. Typical humic acid compositions may include a variety of components including quinone, phenol, catechol and sugar moieties as shown below.

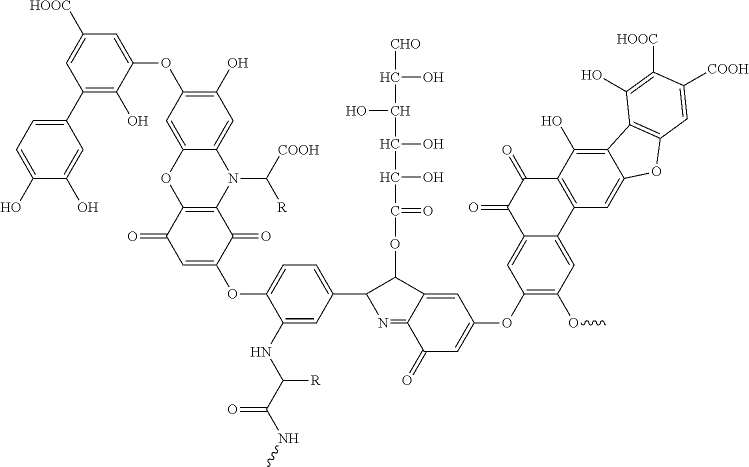

Humic acids can form complexes with ions that are commonly found in the environment creating humic colloids. Humic and fulvic acids (fulvic acids are humic acids of lower molecular weight and higher oxygen content than other humic acids) are commonly used as a soil supplement in agriculture, and less commonly as a human nutritional supplement. As a nutrition supplement, fulvic acid can be found in a liquid form as a component of mineral colloids. Fulvic acids are poly-electrolytes and are unique colloids that diffuse easily through membranes whereas all other colloids do not.

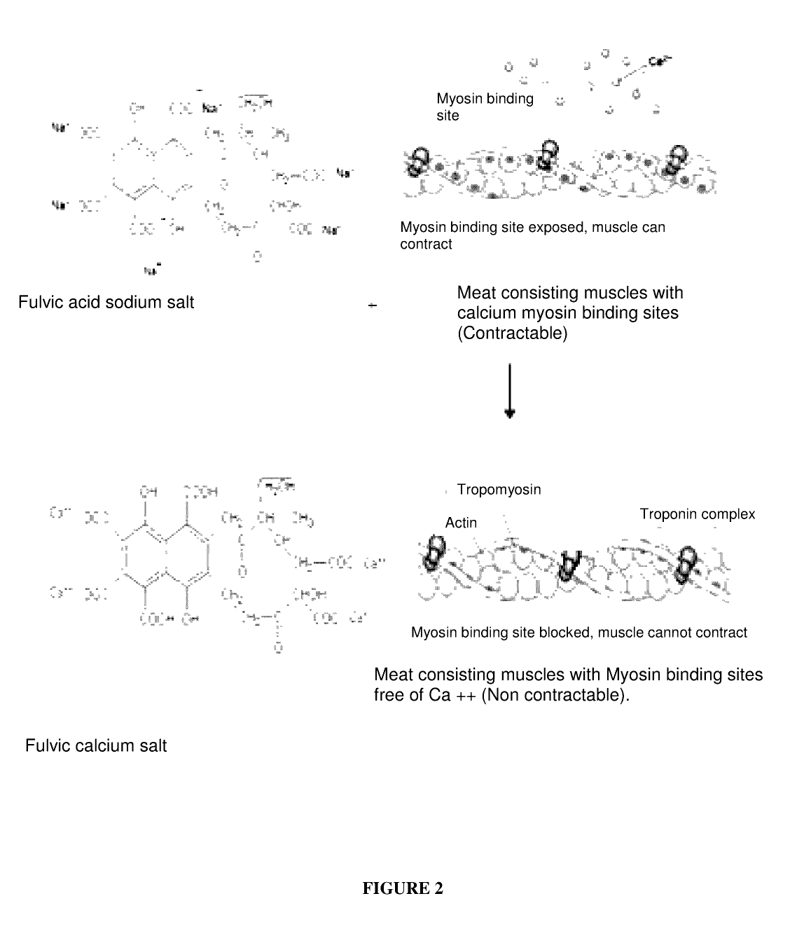

Fulvic acid and its salts are known for their properties for tenderizing meat. Fulvic acid can be derived from natural sources or natural products, as it can be extracted from humus that is found in soil, sediment, or in aquatic environments. In some embodiments, fulvic acid is derived from natural sources. Additionally, fulvic acid was shown to improve the meat quality of pork when fed to domesticated pigs. Fulvic acid salts can act as a cation exchanger. Fulvic acid is one of two classes of natural acidic organic polymer that can be extracted from humus found in soil, sediment, or aquatic environments. Its structure is best characterized as a loose assembly of aromatic organic polymers with many carboxyl groups (COOH) that release hydrogen ions, resulting in species that have electric charges at various sites on the ion. It is especially reactive with metals, forming strong complexes with Fe³⁺, Al³⁺, and Cu²⁺ in particular and leading to their increased solubility in natural waters. Fulvic acid is believed to originate as a product of microbial metabolism, although it is not synthesized as a life-sustaining carbon or energy source. Reference is made to FIG. 2, which shows the reaction scheme of fulvic acid sodium salt binding to calcium from meat, thereby causing the meat to be in a non-contractible state. In some embodiments, a composition for tenderizing meat is provided, wherein the composition comprises fulvic acid. In some embodiments, the fulvic acid comprises a cleaved product of fulvic acid and its sodium salts, and wherein the fulvic acid comprises a 1-10% w/w of the composition as a powder or a 1-10% w/v of the composition as a liquid.

Humic acid and its salts are known for their properties for tenderizing meat. Humic acid salt can act as a cation exchanger like fulvic acid. Cleaved humic acid derivatives can act as sodium salts in the presence of meat that is in a contracted state.

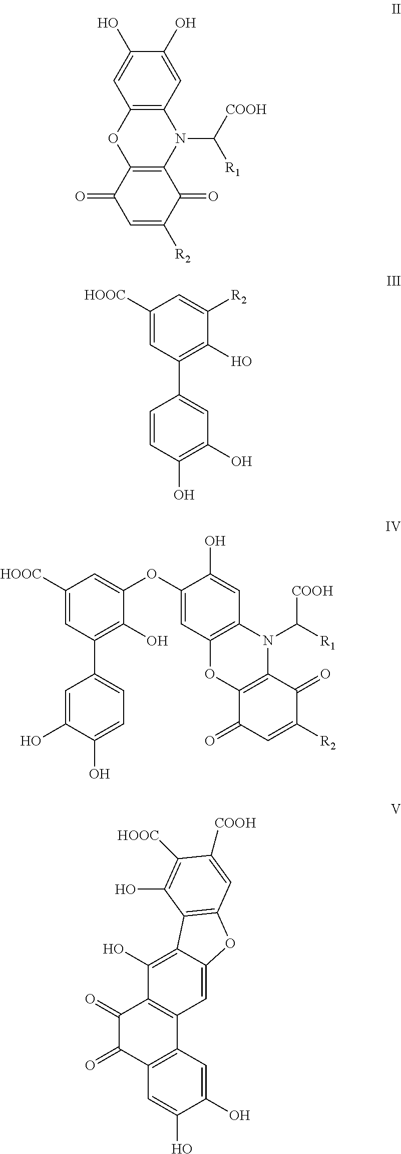

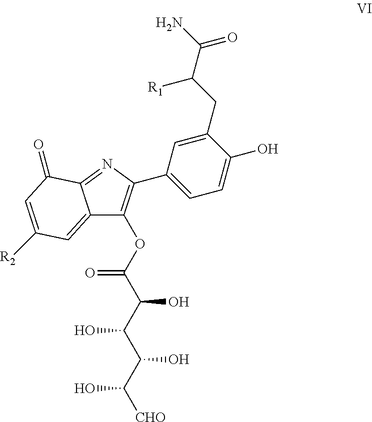

In some embodiments, a composition for tenderizing meat is provided, wherein the composition comprises humic acid or derivatives thereof. In some embodiments, the humic acid comprises a cleaved product of fulvic acid and its sodium salts, and wherein the humic acid comprises a 1-10% w/w of the composition as a powder or a 1-10% w/v of the composition as a liquid.

“Citric acid” as described herein, is a weak organic acid with the formula C₆H₈O₇. It is a natural preservative which can occur naturally in citrus fruits, and therefore can be derived from natural sources or natural products. In some embodiments, citric acid is derived from natural sources. Citric acid can also be used to add an acidic or sour taste to foods and drinks. Citric acid can be used mainly as an acidifier, as a flavoring, and as a chelating agent. Citric acid can act as a mild chelating agent, and can chelate calcium ions, which are known to increase muscle contraction. Pre-rigor mortis citric acid injections have also been previously shown to improve tenderness of meat without affecting the color or the flavor of pork carcasses. Citric acid, salts and chelates may be used to tenderize meat in some embodiments.

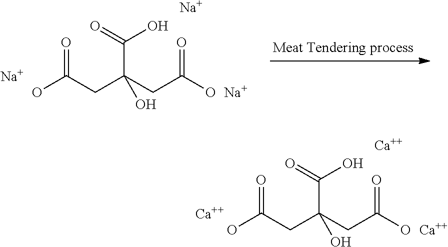

The citrate can be used to bind and chelate Ca²⁺, in a meat tenderizing process. In some embodiments, a composition for tenderizing meat is provided, wherein the composition comprises citric acid. In some embodiments, the citric acid comprises a cleaved product of fulvic acid and its sodium salts, and wherein the citric acid comprises a 1-10% w/w of the composition as a powder or a 1-10% w/v of the composition as a liquid.

“Malic acid,” as described herein, is an organic compound with the formula HO₂CCH₂CHOHCO₂H. It is a dicarboxylic acid that is made by all living organisms and therefore can be derived from natural products or sources such as plants and plant materials. In some embodiments, malic acid is derived from natural sources. Malic acid contributes to the pleasantly sour taste of fruits, and can be used as a food additive. The salts and esters of malic acid are known as malates. The malate anion is an intermediate in the citric acid cycle. Malic acid is also known to chelate divalent cations, for example magnesium and calcium cations. Malic acid sodium salt can be used to contact meat in order to chelate the calcium, rendering a non-contractible state for the meat.

In some embodiments, a composition for tenderizing meat is provided, wherein the composition comprises malic acid. In some embodiments, the malic acid comprises a cleaved product of malic acid and its sodium salts, and wherein the malic acid comprises a 1-10% w/w of the composition as a powder or a 1-10% w/v of the composition as a liquid.

“Gallic acid” as described herein, is a trihydroxybenzoic acid, a type of phenolic acid, a type of organic acid, also known as 3,4,5-trihydroxybenzoic acid, found in gallnuts, sumac, witch hazel, tea leaves, oak bark, and other plants. As such, gallic acid can be derived from natural sources or natural products. In some embodiments, gallic acid is derived from natural sources. The chemical formula is C₆H₂(OH)₃COOH. Gallic acid is found both free and as part of hydrolyzable tannins. Gallic acid has the capacity to chelate free iron as well as calcium cations. Sodium gallate salt can be used to contact meat through its ability to chelate calcium, thus rendering a meat in a non-contractible state.

In some embodiments, a composition for tenderizing meat is provided, wherein the composition comprises gallic acid. In some embodiments, the gallic acid comprises a cleaved product of gallic acid and its sodium salts, and wherein the gallic acid comprises a 1-10% w/w of the composition as a powder or a 1-10% w/v of the composition as a liquid.

“Polyphenols” as described herein, are a structural class of natural, organic chemicals characterized by the presence of large multiples of phenol structural units. Polyphenols can occur in nature and can be found in all families of plants. Without being limiting, examples of plant material in which polyphenols can be found include leaf tissue, the epidemis, bark layers, flowers and fruit. As such, polyphenols can be derived from natural products or natural sources. In some embodiments, polyphenols are derived from natural sources. The number and characteristics of these phenol structures underlie the unique physical, chemical, and by way of example and not of limitation, polyphenols can include tannic acid, and ellagitannin. In some embodiments, a composition for tenderizing meat is provided, wherein the composition comprises polyphenols from natural sources, wherein the natural sources comprises di- and tri-carboxylic acids, phenolic derivatives and their sodium salts.

“Flavonoids” as described herein, are a class of plant secondary metabolites. Flavonoids can also be extracted from natural sources or products, as they are found widely distributed in plants and plant material. In some embodiments, flavonoids are derived from natural sources. In some embodiments, the composition further comprises flavonoids.

“Carboxylic acid” as described herein, refers to an organic compound that contains a carboxyl group COOH. The general formula of a carboxylic acid is R—COOH. Carboxylic acids occur widely. By way of example, carboxylic acids can include the amino acids and as well as other organic acids.

“Additive” as described herein, can refer to a substance that you can add to a food to flavor, enhance its taste and appearance, add vitamins, and add tenderizing components. Without being limiting, additives can be acids, food coloring, color retention agents, flavors, flavor enhancers, humectants, preservatives, stabilizers, tenderizers, enzymes, sweeteners, and or thickeners. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive.

“ρ-coumaric acid” as referred to herein, is a hydroxycinnamic acid, an organic compound that is a hydroxy derivative of cinnamic acid, as shown below.

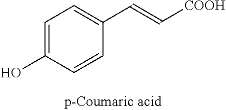 [SMILES: O=C(O)/C=C/c1ccc(O)cc1]

There are three isomers of coumaric acid; o-coumaric acid, m-coumaric acid, and p-coumaric acid that differ by the position of the hydroxy substitution of the phenyl group. p-Coumaric acid is the most abundant isomer of the three in nature. p-coumaric acid exists in two forms trans-p-coumaric acid and cis-p-coumaric acid. p-coumaric acid can be found in a variety of edible plants such as navy beans, carrots, tomatoes, peanuts, and garlic. Therefore, it can be extracted from natural sources or natural products. In some embodiments, p-coumaric acid is derived from natural sources. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the at least one additive is ρ-coumaric acid.

“Tyrosol” as described herein (also spelled “Tirosol”), refers to a phenylethanoid, a derivative of phenethyl alcohol and is shown below.

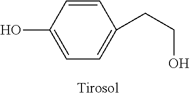

It is a natural phenolic antioxidant present in a variety of natural sources. It is also one of the main natural phenols in argan oil and olive oil. As such, tyrosol can be extracted from natural products or natural sources. In some embodiments, Tyrosol is derived from natural sources. As an antioxidant, tyrosol can protect cells against injury due to oxidation. Although it is not as potent as other antioxidants present in olive oil, its higher concentration and good bioavailability indicate that it may have an important overall effect. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the at least one additive is tyrosol.

“Hydroxytyrosol” as described herein, refers to a phenylethanoid, a type of phenolic phytochemical with antioxidant properties in vitro. In nature, hydroxytyrosol is found in olive leaf and olive oil, in the form of its elenolic acid ester oleuropein and, especially after degradation, in its plain form, of which the structure is shown below.

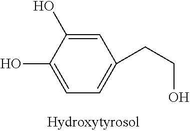 [SMILES: OCCc1ccc(O)c(O)c1]

As such, hydrotyrosol can be extracted from natural products or natural sources. In some embodiments, hydrotyrosol is derived from natural sources. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the at least one additive is hydroxytyrosol.

“Vanillic acid” as described herein, refers to a dihydroxybenzoic acid derivative used as a flavoring agent, and is shown below.

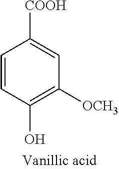 [SMILES: COc1cc(C(=O)O)ccc1O]

It is an oxidized form of vanillin. It is also an intermediate in the production of vanillin from ferulic acid. Vanillic acid can be obtained from plants, for example, in the root of Angelica sinensis. In some embodiments, vanillic acid is derived from natural sources. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the at least one additive is vanillic acid.

“Syringic acid” as described herein, is a naturally occurring O-methylated trihydroxybenzoic acid, a type of chemical compound. The structure is shown below.

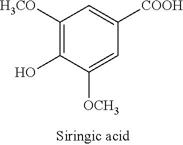 [SMILES: COc1cc(C(=O)O)cc(OC)c1O]

Syringic acid can be found in plants, for example in Ardisia elliptica, an evergreen tree. As such, syringic acid can be extracted from natural products or natural sources. In some embodiments, syringic acid is derived from natural sources. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the at least one additive is syringic acid.

“Caffeic acid” as described herein, refers to an organic compound that is classified as hydroxycinnamic acid, and is shown below.

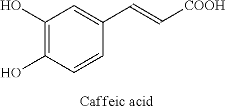 [SMILES: O=C(O)/C=C/c1ccc(O)c(O)c1]

This yellow solid consists of both phenolic and acrylic functional groups. It is found in all plants because it is a key intermediate in the biosynthesis of lignin, one of the principal components of plant biomass and its residues. Caffeic acid can be found, for example, in the bark of Eucalyptus blobulus, in the freshwater fern Salvinia molesta, and in the mushroom Phellinus linteus. As such, caffeic acid can be extracted from natural products or natural sources. In some embodiments, caffeic acid is derived from natural sources. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the at least one additive is caffeic acid.

“Ferulic acid” as described herein, refers to a hydroxycinnamic acid, a type of organic compound and is shown below.

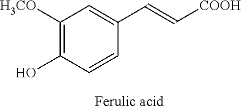 [SMILES: COc1cc(/C=C/C(=O)O)ccc1O]

It is an abundant phenolic phytochemical found in plant cell wall components such as arabinoxylans as covalent side chains. For example, ferulic acid can be found in the dried latex produced from giant fennel, Ferula communis, in the invasive plant species, Carpobrotus edulus, the seeds of coffee, apple, artichoke, peanut, and orange, as well as in both seeds and cell walls of plants, for example, commelinid plants (such as rice, wheat, oats, the Chinese water chestnut (Eleocharis dukis) and pineapple). As such, ferulic acid can be extracted from natural products or natural sources. In some embodiments, ferulic acid is derived from natural sources. It is related to trans-cinnamic acid. As a component of lignin, ferulic acid is a precursor in the manufacture of other aromatic compounds. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the at least one additive is ferulic acid.

“Sinapic acid” or sinapinic acid as described herein, refers to a small naturally occurring hydroxycinnamic acid and is shown below.

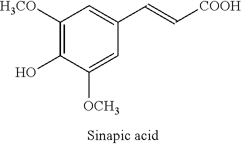 [SMILES: COc1cc(/C=C/C(=O)O)cc(OC)c1O]

Sinapic acid can be found, for example in plant material, such as black mustard seeds. As such, sinapic acid can be extracted from natural products or natural sources. In some embodiments, sinapinic acid is derived from natural sources. It is a member of the phenylpropanoid family. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the at least one additive is sinapic acid.

“Cinnamic acid” as described herein, refers to an organic compound with the formula C₆H₅CHCHCO₂H and is shown below.

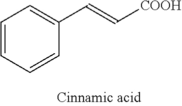 [SMILES: O=C(O)/C=C/c1ccccc1]

It is a white crystalline compound that is slightly soluble in water. Classified as an unsaturated carboxylic acid, it occurs naturally in a number of plants. For example, without being limiting, cinnamic acid can be found in the oil of cinnamon. As such, cinnamic acid can be extracted from natural products or natural sources. In some embodiments, cinnamic acid is derived from natural sources. It is freely soluble in many organic solvents and can exist as both a cis and a trans isomer. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the at least one additive is cinnamic acid.

“Dihydroferulic acid” as described herein, refers to a hydroxycinnamic acid, a type of organic compound and is shown below.

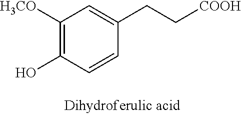 [SMILES: COc1cc(CCC(=O)O)ccc1O]

It is an abundant phenolic phytochemical found in plant cell wall components such as arabinoxylans as covalent side chains. It is related to trans-cinnamic acid. As a component of lignin, ferulic acid is a precursor in the manufacture of other aromatic compounds. Without being limiting, for example, dihydroferulic acid can be found in the seeds of coffee, apple, artichoke, peanut, and orange, as well as in both seeds and cell walls of commelinid plants (such as rice, wheat, oats, the Chinese water chestnut (Eleocharis dukis) and pineapple). As such, dihydroferulic acid can be extracted from natural products or natural sources. In some embodiments, dihyroferulic acid is derived from natural sources. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the at least one additive is dihydroferulic acid.

“Oleuropein” as described herein, refers to a phenylethanoid, a type of phenolic compound found in olive leaf from the olive tree together with other closely related compounds such as 10-hydroxyoleuropein, ligustroside, and 10-hydroxyligustroside and is shown below.

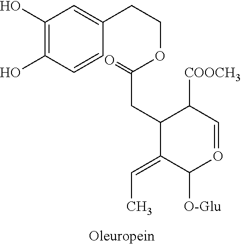

As such, oleuropein can be extracted from natural products or natural sources. In some embodiments, oleuropein is derived from natural sources. These compounds are tyrosol esters of elenolic acid that are further hydroxylated and glycosylated. Oleuropein and its metabolite hydroxytyrosol have powerful antioxidant activity both in vivo and in vitro and give extra-virgin olive oil its bitter, pungent taste. Oleuropein preparations have been claimed for several pharmacological effects, which can include but it is not limited to strengthening of the immune system. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the at least one additive is oleuropein.

“Ellagic acid” as described herein, refers to a natural phenol antioxidant found in numerous fruits and vegetables and is shown below.

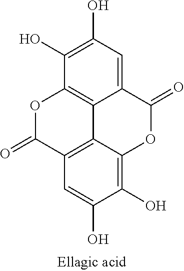 [SMILES: O=c1oc2c(O)c(O)cc3c(=O)oc4c(O)c(O)cc1c4c23]

Without being limiting, for example, ellagic acid can be found in the oak species Quercus alba and in Quercus robur, the macrophyte Myriophyllum spicatum, and in fruits and plant food, such as, for example, blackberries, cranberries, pecans, pomegranates, raspberries, strawberries, walnuts, wolfberries, grapes, and peaches. As such, ellagic acid can be extracted from natural products or natural sources. In some embodiments, ellagic acid is derived from natural sources. The antiproliferative and antioxidant properties of ellagic acid have prompted research into its potential health benefits. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the at least one additive is ellagic acid.

“Glansrin” as described herein, refers to ellagitannins, a diverse class of hydrolyzable tannins, a type of polyphenol formed primarily from the oxidative linkage of galloyl groups in 1,2,3,4,6-pentagalloyl glucose and is shown below.

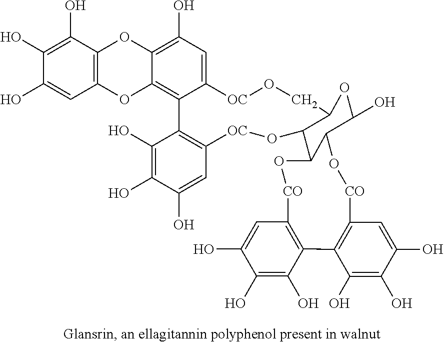

Ellagitannins differ from gallotannins, in that their galloyl groups are linked through C—C bonds, whereas the galloyl groups in gallotannins are linked by peptide bonds. Ellagitannins can be found, for example, in fruits, such as red raspberry. Rubus idaeu. As such, ellagitannins can be extracted from natural products or natural sources. In some embodiments, ellagitannins or glansrin is derived from natural sources. Ellagitannins contain various numbers of hexahydroxydiphenoyl (HHDP) units, as well as galloyl units and/or sanguisorboyl units bounded to sugar moiety. In order to determine the quantity of every individual unit, the hydrolysis of the extracts with trifluoroacetic acid in methanol/water system is performed. Hexahydroxydiphenic acid, created after hydrolysis, spontaneously lactonized to ellagic acid, and sanguisorbic acid to sanguisorbic acid dilactone, while gallic acid remains intact. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the at least one additive is glansrin.

“Tannic acid” as described herein, refers to is a specific commercial form of tannin, a type of polyphenol and is shown below.

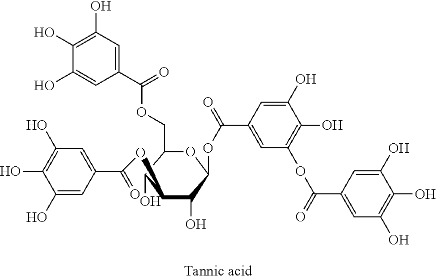

Its weak acidity (pKa around 10) is due to the numerous phenol groups in the structure. Tannic acid can be extracted from plant parts, such as, for example, tara pods (Caesalpinia spinosa), gallnuts from Rhus semialata or Quercus infectoria, and Sicilian sumac leaves (Rhus coriaria). As such, tannic acid can be extracted from natural products or natural sources. In some embodiments, tannic acid is derived from natural sources. The chemical formula for commercial tannic acid is often given as C76H52O46, which corresponds with decagalloyl glucose, but in fact it is a mixture of polygalloyl glucoses or polygalloyl quinic acid esters with the number of galloyl moieties per molecule ranging from 2 up to 12 depending on the plant source used to extract the tannic acid. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the at least one additive is tannic.

“Taxifolin” as described herein, refers to a flavanonol, which is a type of flavonoid (shown below).

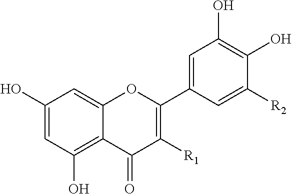

Taxifolin can be found in plants or plant parts, such as, for example, Siberian larch (Larix sibirica), Pinus roxburghii, Cedrus deodata, the Chinese Yew (Taxus chinensis var. mairei), silymarin extract from milk thistle seeds, and in vinegars from aged cherry wood. As such, taxifolin can be extracted from natural products or natural sources. In some embodiments, taxifolin is derived from natural sources. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the at least one additive is taxifolin.

In some embodiments, the at least one additive comprises ρ-coumaric acid, Tyrosol, hydroxytyrosol, vanillic acid, siringic acid, caffeic acid, ferulic acid, sinapic acid, cinnamic acid, dihydroferulic acid, oleuropein, ellagic acid, glansrin, tannic acid, and/or taxifolin, and wherein the additive comprises a 1-10% w/w of the composition as a powder or a 1-10% w/v of the composition as a liquid.

“Vitamin” as referred to herein, is a group of organic substances essential in small quantities to normal metabolism. In some embodiments, a composition for meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the composition further comprises at least one vitamin. By way of example and not of limitation, vitamins can include vitamin A, vitamin B, vitamin B1, vitamin B2, vitamin B3, vitamin B5, vitamin B6, vitamin B7, vitamin B9, vitamin B12, vitamin C, vitamin D, vitamin E, and Vitamin K. In some embodiments the at least one additive is at least one vitamin. In some embodiments the at least one vitamin comprises vitamin A, vitamin B, vitamin B1, vitamin B2, vitamin B3, vitamin B5, vitamin B6, vitamin B7, vitamin B9, vitamin B12, vitamin C, vitamin D, vitamin E, and/or Vitamin K.

“Sodium tri-polyphosphate” as described herein, refers to an inorganic compound with formula Na₅P₃O₁₀. It is the sodium salt of the polyphosphate penta-anion, which is the conjugate base of triphosphoric acid. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the composition for tenderizing meat further comprises sodium tri-polyphosphate. In some embodiments, the sodium tri-polyphosphate comprises a 1-10% w/w of the composition as a powder or a 1-10% w/v of the composition as a liquid.

As described herein, “spice” refers to a dried seed, fruit, root, bark, or vegetable substance primarily used for flavoring, coloring or preserving food. Sometimes a spice is used to hide other flavors. Without being limiting examples of uses for spice can include flavoring, and for medicinal purposes. Without being limiting, spices can include alkanet root, aniseed, red chilli, black cadamon, white pepper, black pepper, peppercorns, black cumin, capers, celery seed, indian bay leaf, cinnamon, coriander, cubeb, cumin, curry, fennel, fenugreek, garam masala, garlic, ginger, black salt, licorice, pepper, mint, mustard seed, basil, saffron, star anise, turmeric, and coriander. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the composition further comprises at least one spice, and wherein the at least one spice comprises a 1-10% w/w of the composition as a powder or a 1-10% w/v of the composition as a liquid. In some embodiments, the at least one spice comprises alkanet root, aniseed, red chilli, black cadamon, white pepper, black pepper, peppercorns, black cumin, capers, celery seed, indian bay leaf, cinnamon, coriander, cubeb, cumin, curry, fennel, fenugreek, garam masala, garlic, ginger, black salt, licorice, pepper, mint, mustard seed, basil, saffron, star anise, turmeric, and/or coriander.

“Lignin” as described herein, refers to a complex polymer of aromatic alcohols known as monolignols (shown below).

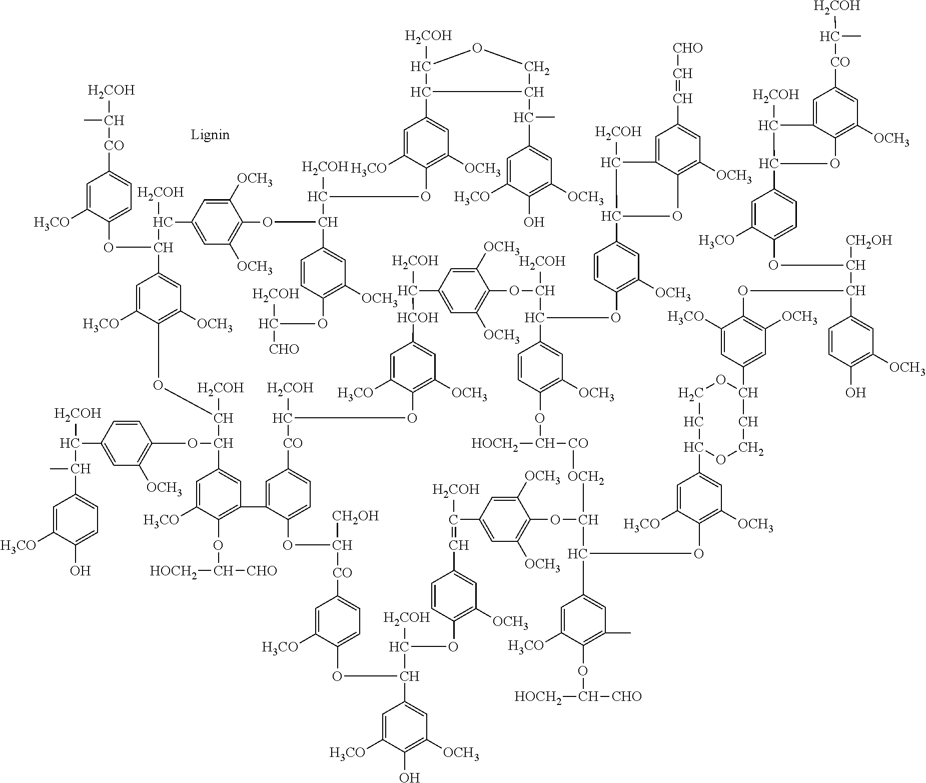

It is most commonly derived from wood, and is an integral part of the secondary cell walls of plants and some algae. As such, lignin can be extracted from natural products or natural sources. In some embodiments, lignin is derived from natural sources. The structure of lignin is across-linked racemic macromolecule. It is relatively hydrophobic and aromatic in nature. The degree of polymerization in nature is difficult to measure, since it is fragmented during extraction and the molecule consists of various types of substructures that appear to repeat in a haphazard manner. Different types of lignin have been described depending on the means of isolation.

There are three monolignol monomers, methoxylated to various degrees: p-coumaryl alcohol, coniferyl alcohol, and sinapyl alcohol. These lignols are incorporated into lignin in the form of the phenylpropanoids p-hydroxyphenyl (H), guaiacyl (G), and syringyl (S), respectively. All lignins contain small amounts of incomplete or modified monolignols, and other monomers are prominent in non-woody plants.

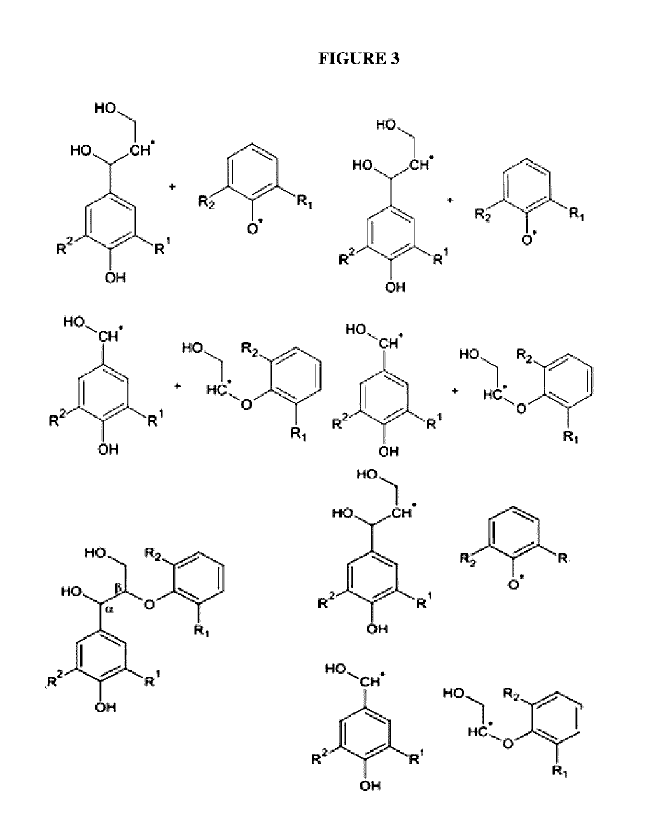

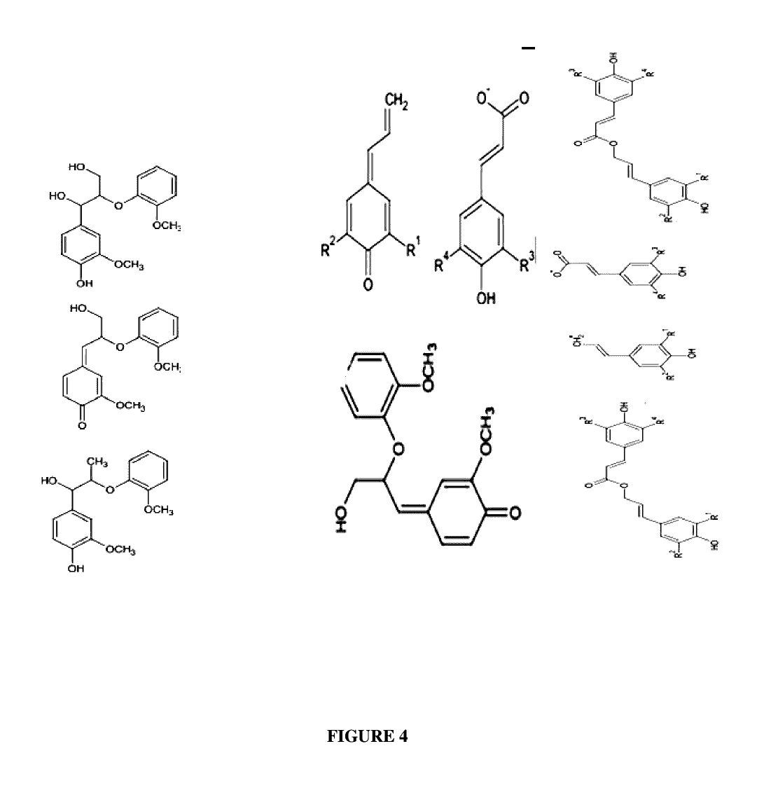

Lignin can undergo cleavage, as illustrated in FIG. 3, as well as undergo thermooxidative degradation, as illustrated in FIG. 4. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the composition further comprises lignin and/or a lignin derivative thereof, wherein the lignin derivative is obtained by lignin cleavage by thermal decomposition, thermooxidative decomposition or catalytic cleavage, and wherein the lignin and/or lignin derivative comprises a 1-10% w/w of the composition as a powder or a 1-10% w/v of the composition as a liquid.

“Meat” as described herein, refers to animal flesh that is eaten as a food source. Meat most often refers to skeletal muscle and associated fat and other tissues. Without being limiting sources of meat can come from lamb, sheep, goat, cattle, domestic pigs and poultry. In some embodiments, a composition for tenderizing meat is provided, wherein the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the meat is selected from lamb, beef, poultry and pork.

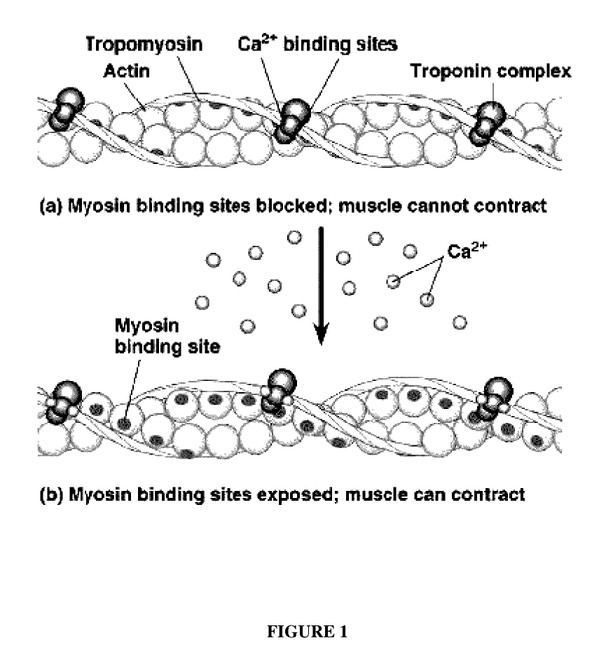

Ingredients are described herein that can retard the contraction of muscles in the meat based on the confirmed mechanism of the muscle contraction. FIG. 1 shows a representative diagram showing muscle contraction mechanism via myosin calcium binding sites. As shown in panel A, when intracellular calcium is low (<10⁻⁸ M), tropomyosin blocks all actin site along one turn of the actin helix. As shown in panel B, when intracellular calcium is elevated (>10⁻⁷M), calcium binds to troponin which then alters the position of tropomyosin on the actin filament. Once tropomyosin has moved, the actin sites are exposed allowing myosin heads to attach.

Rigor mortis is one sign of death and is seen as a chemical changes in the muscles after death, causing the limbs of the corpse to become stiff and difficult to move or manipulate. Rigor mortis is very important in meat technology. The onset of rigor mortis and its resolution partially determines the tenderness of meat. If the post slaughter meat is immediately chilled to 15° C. (59° F.), a phenomenon known as cold shortening occurs, where the muscle sarcomeres shrink to a third of their original length.

Cold shortening is caused by the release of stored calcium ions from the sarcoplasmic reticulum of muscle fibers in response to the cold stimulus. The calcium ions trigger powerful muscle contraction aided by ATP molecules. To prevent cold shortening, a process known as electrical stimulation is carried out, especially in beef carcasses, immediately after slaughter and skinning. In this process, the carcass is stimulated with alternating current, causing it to contract and relax, which depletes the ATP reserve from the carcass and prevents cold shortening.

In the 8 to 10 hours immediately following slaughter, a carcass of beef undergoes rigor mortis, during which process muscles in the carcass naturally contract, thereby resulting in increased meat toughness. While some toughness can be alleviated by aging the meat, this requires storing the meat for some period of time before consumption, with the associated energy and logistic costs.

Standard meat processing during this period of time requires chilling the carcass or primal cut. As temperature declines during chilling, the pH of the meat also declines, such that meat with a pH just above 7.0, which is typical at slaughter, will have a final pH of about 5.4, depending on the amount of glycogen stored in the muscle. The relationship between temperature and pH changes has major impacts on the dynamics of muscle fibers.

If the carcass undergoes rigor at higher than optimum temperature, the pH declines too fast. For example, if the pH falls below 6.0 while the loin temperature is greater than 35° C., the sarcomeres gather together, and the meat becomes tough even upon aging; this is termed ‘heat shortening.’ Conversely if the carcass is chilled too quickly, for example entering rigor while the muscle temperature is below 15° C., the pH decline is too slow, and the meat is toughened; this is termed ‘cold shortening’. Toughness from either heat or cold shortening cannot be alleviated by aging in the majority of cases.

Meat tenderness can be significantly improved if select high-value muscles (the primal cuts) are prevented from contracting, or even forced to lengthen, during rigor, thus resulting in a decreased need for aging and benefits across livestock producers, meat processors, wholesale distributors, retailers, and consumers. Inventions are sought which encompass materials, structures, or systems to regulate and optimize thermodynamic and chemical properties during rigor, in order to simultaneously prevent contraction of specific muscles, for example by mechanical means to tenderstretch or superstretch the muscles, thus producing higher value meat.

However, there is a need for cheaper and faster ways to prevent the contraction of the meat after slaughter. The animals can be fed specific compositions before slaughter, or the animal flesh can be treated with compositions for tenderizing before rigor mortis sets in.

As depicted in FIG. 1, replacing earth alkaline ions mainly calcium and magnesium ions present in the binding site of the muscles can prevent the muscle in the meat from contracting thus leading to successful processing tendered meat. The natural products that are capable of replacing alkaline earth metal ions are: fulvic acid, humic acid, their cleaved products, and their sodium salts, citric acid and its sodium salts, malic acid and its sodium salts, gallic acid and its sodium salts and other natural sources consisting di and tri carboxylic acids and their sodium salts.

The chemical explanation, for adding these natural products is for replacing divalent ions Ca⁺⁺ and Mg⁺⁺ ions, which are confirmed binding cations for binding sites in muscle fibers which lead to muscle contraction, with sodium ions or H+ which are in active in contraction of muscles. In an example reaction scheme of FIG. 2, fulvic acid sodium salt is added to contracted meat that has been bound with calcium. The fulvic acid sodium salt is able to chelate the calcium ions rendering a muscle that cannot contract and is thus tenderized. Additionally, the presence of sodium salt in the muscle will lead to absorption of water into the muscle based on osmotic phenomenon which will lead to further extension of the muscles in the meat thus enhancing its tenderizing or tenderizing features. Also, this method is very cost effective, and the ingredients are food grade non-toxic chemicals from natural resources. Additionally, the reagents used can be a food ingredient, have additional food additives and antioxidants. Accordingly the nutrition value of the final treated meat will be enhanced by this tenderizing or tenderizing process plus it increases the stability and oxidation resistance, thus maintaining the original color and freshness. Other benefits of the composition comprising a chelator is that the composition would be easy to apply as the elements in the composition are completely soluble in water thus can be applied by spraying, injection, immersion or possibly injection or feeding the animal pre-slaughtering. The ingredients are easy to prepare and to apply, as their salts are completely soluble in water thus can be applied by spraying, injection, immersion or possibly feeding pre slaughtering as they are small molecules which act as internal antioxidants and pH regulators. In some embodiments, methods are provided for tenderizing meat, wherein the meat is tenderized by contact with a composition for meat tenderizing. In some embodiments the composition is applied by spraying, injection, immersion or feeding and animal prior to slaughtering.

Compositions can also include additives such as vitamins, spices and/or preservatives for added flavor, nutrients and/or the preservation of the meat. In some embodiments, compositions for tenderizing meat comprise vitamins, spices and/or preservatives for added flavor, nutrients and/or the preservation of the meat.

In some embodiments, a composition for tenderizing meat is provided such that the composition can be given to an animal before slaughter or the composition can be contacted with the animal meat post-slaughter. In some embodiments, the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts and at least one additive. In some embodiments, the composition is a powder or a liquid.

As the pH of the meat also plays a role in the contraction of the muscle, the pH of the meat tenderizing composition must also be taken into consideration. In some embodiments, the composition is a liquid having a pH of about 5.0 to about 7.0. In some embodiments, the fulvic acid comprises a cleaved product of fulvic acid and its sodium salts, and wherein the fulvic acid comprises a 1-10% w/w of the composition as a powder or a 1-10% w/v of the composition as a liquid. In some embodiments, the humic acid comprises a cleaved product of humic acid, and its sodium salts, and wherein the humic acid comprises a 1-10% w/w of the composition as a powder or a 1-10% w/v of the composition as a liquid. In some embodiments, the citric acid comprises citric acid chelates and citric acid sodium salts, and wherein the citric acid comprises a 1-10% w/w of the composition as a powder or a 1-10% w/v of the composition as a liquid. In some embodiments, the malic acid comprises malic acid chelates and malic acid sodium salts, and wherein the malic acid comprises a 1-10% w/w of the composition as a powder or a 1-10% w/v of the composition as a liquid. In some embodiments, the gallic acid comprises gallic acid chelates and gallic acid sodium salts, and wherein the gallic acid comprises a 1-10% w/w of the composition as a powder or a 1-10% w/v of the composition as a liquid. In some embodiments, the composition further comprises sodium carbonate, and wherein the sodium carbonate comprises a 1-10% w/w of the composition as a powder or a 1-10% w/v of the composition as a liquid. In some embodiments, the composition further comprises sodium tri-polyphosphate. In some embodiments, the sodium tri-polyphosphate comprises a 1-10% w/w of the composition as a powder or a 1-10% w/v of the composition as a liquid. In some embodiments, the composition further comprises at least one vitamin. In some embodiments, the at least one additive comprises ρ-coumaric acid, Tyrosol, hydroxytyrosol, vanillic acid, siringic acid, caffeic acid, ferulic acid, sinapic acid, cinnamic acid, dihydroferulic acid, oleuropein, ellagic acid, glansrin, tannic acid, and/or taxifolin, and wherein the additive comprises a 1-10% w/w of the composition as a powder or a 1-10% w/v of the composition as a liquid. In some embodiments, the composition further comprises at least one spice, and wherein the at least one spice comprises a 1-10% w/w of the composition as a powder or a 1-10% w/v of the composition as a liquid. In some embodiments, the composition further comprises lignin and/or a lignin derivative thereof, wherein the lignin derivative is obtained by lignin cleavage by thermal decomposition, thermooxidative decomposition or catalytic cleavage, and wherein the lignin and/or lignin derivative comprises a 1-10% w/w of the composition as a powder or a 1-10% w/v of the composition as a liquid.

Tenderizing the meat is a process which involves tenderizing the meat as soon as the animal is slaughtered, before the release of calcium ions in the system that can lead to the rigor mortis process. In some embodiments, a method of tenderizing meat is provided. In the broadest sense the method can comprise contacting said meat with a composition for tenderizing meat under conditions such that the meat is tenderized, wherein the said composition is a powder or a liquid, and comprises a 1-10% w/w as a powder or a 1-10% w/v as a liquid, of at least one of fulvic acid, humic acid, citric acid, malic acid, gallic acid, and/or polyphenols from natural sources, wherein the natural sources comprises di- and tri-carboxylic acids, phenolic derivatives, and their sodium salts, and further comprises at least one additive. In some embodiments, the composition is a liquid and having a pH of about 5.0 to about 7. In some embodiments, the composition further comprises sodium carbonate, wherein the sodium carbonate comprises a 1-10% w/w of the composition as a powder or a 1-10% w/v of the composition as a liquid. In some embodiments, the composition further comprises sodium tri-polyphosphate, and wherein the sodium tri-polyphosphate comprises a 1-10% w/w of the composition as a powder or a 1-10% w/v of the composition as a liquid. In some embodiments, the composition further comprises a vitamin. In some embodiments, the at least one additive comprises ρ-coumaric acid, Tyrosol, hydroxytyrosol, vanillic acid, siringic acid, caffeic acid, ferulic acid, sinapic acid, cinnamic acid, dihydroferulic acid, oleuropein, ellagic acid, glansrin, tannic acid, and/or taxifolin and wherein the at least one additive comprises a 1-10% w/w of the composition as a powder or a 1-10% w/v of the composition as a liquid. In some embodiments, the composition further comprises at least one spice, and wherein the at least one spice comprises a 1-10% w/w of the composition as a powder or a 1-10% w/v of the composition as a liquid. In some embodiments, the composition further comprises lignin and/or a lignin derivative thereof, wherein the lignin derivative is obtained by lignin cleavage by thermal decomposition, thermooxidative decomposition or catalytic cleavage, and wherein the lignin and/or lignin derivative comprises a 1-10% w/w of the composition as a powder or a 1-10% w/v of the composition as a liquid. In some embodiments, the meat is selected from lamb, beef, poultry and pork. In some embodiments, the contacting comprises coating the composition onto a surface of the meat. In some embodiments, a total surface of the meat is substantially coated with the composition. In some embodiments, the composition is a liquid and the contacting comprises injecting the meat with the composition. In some embodiments, the composition is injected in an amount of at least 1-2% v/w of the meat. In some embodiments, the contacting comprises immersing the meat in the composition, wherein the composition is a liquid. In some embodiments, the contacting is performed for 5, 6, 7, 8, 9, 10, 11, 12, 13, 14, 15, 16, 17, 18, 19, 20, 21, 22, 23, 24, 25. 26, 27, 28, 29 or 30 minutes or any other value in a range defined by any two of these values. In some embodiments, the contacting is performed a 5° C., 6° C., 7° C., 8° C., 9° C., or 10° C. or any other value in a range defined by any two of these values. In some embodiments, the contacting comprises injecting or feeding the composition to an animal before slaughter. In some embodiments, the composition is 1 gallon/2-4 kg of meat, and wherein the composition is a liquid. In some embodiments, the composition is 1 gallon per 2 kg, 2.2 kg, 2.4 kg, 2.6 kg, 2.8 kg, 3.0 kg, 3.2 kg, 3.4 kg, 3.6 kg, 3.8 kg, or 4 kg of meat or any other value in a range defined by any two of these values, and wherein the composition is a liquid. In some embodiments, the composition is 1 gallon per 2 kg, 2.2 kg, 2.4 kg, 2.6 kg, 2.8 kg, 3.0 kg, 3.2 kg, 3.4 kg, 3.6 kg, 3.8 kg, or 4 kg of meat or any other value in a range defined by any two of these values, and wherein the composition is a liquid and wherein the meat part is covered with the tenderizing solution. In some embodiments, the contacting is performed at 1, 2, 3, 4, 5, 6, 7, 8, 9, 10, 11, 12, 13, 14, 15, 16, 17 or 18 hours after slaughter, or any other value in a range defined by any two of these values.

Meat Tenderizing Using Compositions with Lignin Hydrolyzed and Cleaved Products

In some embodiments, compositions for tenderizing meat can further comprise lignins and/or fragmented lignin that is obtained by its cleavage and/or thermo oxidative degradation by several processes. Cleaved lignin and/or thermo oxidative products, which are all substituted phenolic derivatives, can act as antioxidants, preservatives and chelating agents to extract calcium and magnesium ions and/or to react with chemical agents which are responsible of muscle contraction in the meat. The mechanism of these new active ingredient act is based on the well-known process of tenderizing, preserving and flavoring meat by smoking because the smoke produced from lignin burning and charcoal consists of aromatic phenols formed from the thermo-oxidative degradation of lignin. In other words, the process can use the same active ingredients, but these ingredients may be produced from lignin by chemical cleavage and thermo oxidative processes of the aromatic ether linkage of phenolic structures in lignin, rather than by smoking. In some embodiments, the composition further comprises lignins and/or derivatives of lignin.

The thermo-oxidative product mixture or individual phenolic derivatives such as vanilla obtained from good sourced lignin under predetermined conditions can also be used for meat preserving and tenderizing. The method is cheap, cost effective, natural non-toxic chemicals from lignin, food additives, preservative, and antioxidants accordingly the nutrition value of the final treated meat will be enhanced by this tenderizing process plus increasing the stability, oxidation resistant and maintaining the original color and freshness. In some embodiments, a composition for meat tenderizing is provided, wherein the composition comprises thermo-oxidative product mixture or individual phenolic derivatives from lignin.

### ADDITIONAL EMBODIMENTS

In some embodiments, a composition for tenderizing meat is provided. In some embodiments, the composition comprises at least one of fulvic acid, humic acid, citric acid, malic acid, gallic acid, and/or polyphenols from natural sources, wherein the natural sources comprises di- and tri-carboxylic acids, phenolic derivatives and their sodium salts, wherein the natural sources are selected from plant, plant material, and organisms, and at least one additive. In some embodiments, the composition is a powder or a liquid. In some embodiments, the composition is a liquid having a pH of about 5.0 to about 7.0. In some embodiments, the fulvic acid comprises a cleaved product of fulvic acid and its sodium salts, and wherein the fulvic acid comprises a 1-10% w/w of the composition as a powder or a 1-10% w/v of the composition as a liquid. In some embodiments, the humic acid comprises a cleaved product of humic acid, and its sodium salts, and wherein the humic acid comprises a 1-10% w/w of the composition as a powder or a 1-10% w/v of the composition as a liquid. In some embodiments, the citric acid comprises citric acid chelates and citric acid sodium salts, and wherein the citric acid comprises a 1-10% w/w of the composition as a powder or a 1-10% w/v of the composition as a liquid. In some embodiments, the malic acid comprises malic acid chelates and malic acid sodium salts, and wherein the malic acid comprises a 1-10% w/w of the composition as a powder or a 1-10% w/v of the composition as a liquid. In some embodiments, the gallic acid comprises gallic acid chelates and gallic acid sodium salts, and wherein the gallic acid comprises a 1-10% w/w of the composition as a powder or a 1-10% w/v of the composition as a liquid. In some embodiments, the composition further comprises sodium carbonate, and wherein the sodium carbonate comprises a 1-10% w/w of the composition as a powder or a 1-10% w/v of the composition as a liquid. In some embodiments, the composition further comprises sodium tri-polyphosphate. In some embodiments, the sodium tri-polyphosphate comprises a 1-10% w/w of the composition as a powder or a 1-10% w/v of the composition as a liquid. In some embodiments, the composition further comprises at least one vitamin. In some embodiments, the at least one additive comprises ρ-coumaric acid, Tyrosol, hydroxytyrosol, vanillic acid, siringic acid, caffeic acid, ferulic acid, sinapic acid, cinnamic acid, dihydroferulic acid, oleuropein, ellagic acid, glansrin, tannic acid, and/or taxifolin, and wherein the additive comprises a 1-10% w/w of the composition as a powder or a 1-10% w/v of the composition as a liquid. In some embodiments, the composition further comprises at least one spice, and wherein the at least one spice comprises a 1-10% w/w of the composition as a powder or a 1-10% w/v of the composition as a liquid. In some embodiments, the composition further comprises lignin and/or a lignin derivative thereof, wherein the lignin derivative is obtained by lignin cleavage by thermal decomposition, thermooxidative decomposition or catalytic cleavage, and wherein the lignin and/or lignin derivative comprises a 1-10% w/w of the composition as a powder or a 1-10% w/v of the composition as a liquid.

In some embodiments, a method of tenderizing meat is provided. In the broadest sense the method can comprise contacting said meat with a composition for tenderizing meat under conditions such that the meat is tenderized, wherein the said composition is a powder or a liquid, and comprises a 1-10% w/w as a powder or a 1-10% w/v as a liquid, of at least one of fulvic acid, humic acid, citric acid, malic acid, gallic acid, and/or polyphenols from natural sources, wherein the natural sources comprises di- and tri-carboxylic acids, phenolic derivatives, and their sodium salts, wherein the natural sources are selected from plant, plant material, and organisms, and further comprises at least one additive. In some embodiments, the composition is a liquid and having a pH of about 5.0 to about 7. In some embodiments, the composition further comprises sodium carbonate, wherein the sodium carbonate comprises a 1-10% w/w of the composition as a powder or a 1-10% w/v of the composition as a liquid. In some embodiments, the composition further comprises sodium tri-polyphosphate, and wherein the sodium tri-polyphosphate comprises a 1-10% w/w of the composition as a powder or a 1-10% w/v of the composition as a liquid. In some embodiments, the composition further comprises a vitamin. In some embodiments, the at least one additive comprises ρ-coumaric acid, Tyrosol, hydroxytyrosol, vanillic acid, siringic acid, caffeic acid, ferulic acid, sinapic acid, cinnamic acid, dihydroferulic acid, oleuropein, ellagic acid, glansrin, tannic acid, and/or taxifolin and wherein the at least one additive comprises a 1-10% w/w of the composition as a powder or a 1-10% w/v of the composition as a liquid. In some embodiments, the composition further comprises at least one spice, and wherein the at least one spice comprises a 1-10% w/w of the composition as a powder or a 1-10% w/v of the composition as a liquid. In some embodiments, the composition further comprises lignin and/or a lignin derivative thereof, wherein the lignin derivative is obtained by lignin cleavage by thermal decomposition, thermooxidative decomposition or catalytic cleavage, and wherein the lignin and/or lignin derivative comprises a 1-10% w/w of the composition as a powder or a 1-10% w/v of the composition as a liquid. In some embodiments, the meat is selected from lamb, beef, poultry and pork. In some embodiments, the contacting comprises coating the composition onto a surface of the meat. In some embodiments, a total surface of the meat is substantially coated with the composition. In some embodiments, the composition is a liquid and the contacting comprises injecting the meat with the composition. In some embodiments, the composition is injected in an amount of at least 1-2% v/w of the meat. In some embodiments, the contacting comprises immersing the meat in the composition, wherein the composition is a liquid. In some embodiments, the contacting is performed for 5, 6, 7, 8, 9, 10, 11, 12, 13, 14, 15, 16, 17, 18, 19, 20, 21, 22, 23, 24, 25. 26, 27, 28, 29 or 30 minutes or any other value in a range defined by any two of these values. In some embodiments, the contacting is performed a 5° C., 6° C., 7° C., 8° C., 9° C., or 10° C. or any other value in a range defined by any two of these values. In some embodiments, the contacting comprises injecting or feeding the composition to an animal before slaughter. In some embodiments, the composition is 1 gallon/2-4 kg of meat, and wherein the composition is a liquid. In some embodiments, the composition is 1 gallon per 2 kg, 2.2 kg, 2.4 kg, 2.6 kg, 2.8 kg, 3.0 kg, 3.2 kg, 3.4 kg, 3.6 kg, 3.8 kg, or 4 kg of meat or any other value in a range defined by any two of these values. In some embodiments, the composition is 1 gallon per 2 kg, 2.2 kg, 2.4 kg, 2.6 kg, 2.8 kg, 3.0 kg, 3.2 kg, 3.4 kg, 3.6 kg, 3.8 kg, or 4 kg of meat or any other value in a range defined by any two of these values, and wherein the composition is a liquid and wherein the meat part is covered with the tenderizing solution. In some embodiments, the contacting is performed at 1, 2, 3, 4, 5, 6, 7, 8, 9, 10, 11, 12, 13, 14, 15, 16, 17 or 18 hours after slaughter, or any other value in a range defined by any two of these values.

In some embodiments, a tenderized meat is provided. In the broadest sense, the tenderized meat can comprise a meat selected from lamb, beef, poultry and pork, wherein the tenderized meat comprises a powder or a liquid composition, comprising a 1-10% w/w as a powder or a 1-10% w/v as a liquid, of at least one of fulvic acid, humic acid, citric acid, malic acid, gallic acid, and/or polyphenols from natural sources, wherein the natural sources comprises di- and tri-carboxylic acids, phenolic derivatives, and their sodium salts, wherein the natural sources are selected from plant, plant material, and organisms, and wherein the composition further comprises at least one additive, selected from ρ-coumaric acid, Tyrosol, hydroxytyrosol, vanillic acid, siringic acid, caffeic acid, ferulic acid, sinapic acid, cinnamic acid, dihydroferulic acid, oleuropein, ellagic acid, glansrin, tannic acid, and taxifolin.

The foregoing detailed description of embodiments refers to the accompanying drawings, which illustrate specific embodiments of the present disclosure. Other embodiments having different structures and operations do not depart from the scope of the present disclosure. The term “the invention” or the like is used with reference to certain specific examples of the many alternative aspects or embodiments of the applicants' invention set forth in this specification, and neither its use nor its absence is intended to limit the scope of the applicants' invention or the scope of the claims. This specification is divided into sections for the convenience of the reader only. Headings should not be construed as limiting of the scope of the invention. The definitions are intended as a part of the description of the invention. It will be understood that various details of the present invention may be changed without departing from the scope of the present invention. Furthermore, the foregoing description is for the purpose of illustration only, and not for the purpose of limitation.

All publications, including patent documents and scientific articles, referred to in this application and the bibliography and attachments are incorporated by reference for the referenced materials and in their entireties for all purposes to the same extent as if each individual publication were individually incorporated by reference.

Citation of the above publications or documents is not intended as an admission that any of the foregoing is pertinent prior art, nor does it constitute any admission as to the contents or date of these publications or documents.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention. The various embodiments of the invention should be understood that they have been presented by way of example only, and not by way of limitation. Likewise, the various diagrams may depict an example architectural or other configuration for the invention, which is done to aid in understanding the features and functionality that can be included in the invention. The invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described. They instead can, be applied, alone or in some combination, to one or more of the other embodiments of the invention, whether or not such embodiments are described, and whether or not such features are presented as being a part of a described embodiment. Thus the breadth and scope of the invention should not be limited by any of the above-described exemplary embodiments.

Terms and phrases used in this document, and embodiments thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless apparent from the context or expressly stated otherwise. Similarly, a group of items linked with the conjunction “or” should not be read as requiring mutual exclusivity among that group, but rather should also be read as “and/or” unless it is apparent from the context or expressly stated otherwise. Furthermore, although items, elements or components of the invention may be described or claimed in the singular, the plural is contemplated to be within the scope thereof unless limitation to the singular is explicitly stated. For example, “at least one” may refer to a single or plural and is not limited to either. The presence of broadening words and phrases such as “one or more,” “at least,” “but not limited to”, or other like phrases in some instances shall not be read to mean that the narrower case is intended or required in instances where such broadening phrases may be absent.

What is claimed is:

1. A composition for tenderizing meat, comprising
at least one organic acid including derivatives and salts thereof, or a polyphenol including derivatives and salts thereof, or both an organic acid and a polyphenol and derivatives and salts thereof, wherein the organic acid and the polyphenol are derived from natural plant or animal sources; and
at least one additive.

2. The composition of claim 1, wherein the composition is a powder or a liquid.

3. The composition of claim 2, wherein the composition is a liquid having a pH of about 5.0 to about 7.0.

4. The composition of claim 1, wherein the organic acid is selected from fulvic acid, humic acid, citric acid, malic acid or gallic acid.

5. The composition of claim 4, wherein the fulvic acid comprises a cleaved product of fulvic acid and its sodium salts, and wherein the fulvic acid comprises from about 1% to about 10% (w/w) of the composition as a powder or from about 1% to about 10% (w/v) of the composition as a liquid.

6. The composition of claim 4, wherein the humic acid comprises a cleaved product of humic acid, and its sodium salts, and wherein the humic acid comprises from about 1% to about 10% (w/w) of the composition as a powder or from about 1% to about 10% (w/v) of the composition as a liquid.

7. The composition of claim 4, wherein the citric acid comprises citric acid chelates and citric acid sodium salts, and wherein the citric acid comprises from about 1% to about 10% (w/w) of the composition as a powder or from about 1% to about 10% (w/v) of the composition as a liquid.

8. The composition of claim 4, wherein the malic acid comprises malic acid chelates and malic acid sodium salts, and wherein the malic acid comprises from about 1% to about 10% (w/w) of the composition as a powder or from about 1% to about 10% (w/v) of the composition as a liquid.

9. The composition of claim 4, wherein the gallic acid comprises gallic acid chelates and gallic acid sodium salts, and wherein the gallic acid comprises from about 1% to about 10% (w/w) of the composition as a powder or from about 1% to about 10% (w/v) of the composition as a liquid.

10. The composition of claim 1, wherein the at least one additive is selected from ρ-coumaric acid, tyrosol, hydroxytyrosol, vanillic acid, siringic acid, caffeic acid, ferulic acid, sinapic acid, cinnamic acid, dihydroferulic acid, oleuropein, ellagic acid, glansrin, tannic acid, or taxifolin, and wherein the additive comprises from about 1% to about 10% (w/w) of the composition as a powder or from about 1% to about 10% (w/v) of the composition as a liquid.

11. The composition of claim 1, further comprising sodium carbonate, wherein the sodium carbonate comprises from about 1% to about 10% (w/w) of the composition as a powder or from about 1% to about 10% (w/v) of the composition as a liquid.

12. The composition of claim 1, further comprising sodium tri-polyphosphate, wherein the sodium tri-polyphosphate comprises from about 1% to about 10% (w/w) of the composition as a powder or from about 1% to about 10% (w/v) of the composition as a liquid.

13. The composition of claim 1, further comprising at least one vitamin.

14. The composition of claim 1, further comprising at least one spice, wherein the at least one spice comprises from about 1% to about 10% (w/w) of the composition as a powder or from about 1% to about 10% (w/v) of the composition as a liquid.

15. The composition of claim 1, further comprising lignin or a lignin derivative, wherein the lignin derivative is obtained by lignin cleavage by thermal decomposition, thermooxidative decomposition or catalytic cleavage, and wherein the lignin or lignin derivative comprises from about 1% to about 10% (w/w) of the composition as a powder or from about 1% to about 10% (w/v) of the composition as a liquid.

16. A method of tenderizing a meat, the method comprising;
contacting said meat with a composition for tenderizing meat under conditions such that the meat is tenderized, wherein the said composition is a powder or a liquid, and comprises from about 1% to about 10% (w/w) of the composition as a powder or from about 1% to about 10% (w/v) of the composition as a liquid, of at least one of an organic acid including derivatives and salts thereof, or a polyphenol including derivatives and salts thereof, or both an organic acid and a polyphenol and derivatives and salts thereof, wherein the organic acid and the polyphenol are derived from natural plant or animal sources, the composition further comprising at least one additive.

17. The method of claim 16, wherein the at least one additive is selected from ρ-coumaric acid, Tyrosol, hydroxytyrosol, vanillic acid, siringic acid, caffeic acid, ferulic acid, sinapic acid, cinnamic acid, dihydroferulic acid, oleuropein, ellagic acid, glansrin, tannic acid, or taxifolin and wherein the at least one additive comprises from about 1% to about 10% (w/w) of the composition as a powder or from about 1% to about 10% (w/v) of the composition as a liquid.

18. The method of claim 16, wherein the composition further comprises lignin and/or a lignin derivative thereof, wherein the lignin derivative is obtained by lignin cleavage by thermal decomposition, thermooxidative decomposition or catalytic cleavage, and wherein the lignin and/or lignin derivative comprises from about 1% to about 10% (w/w) of the composition as a powder or from about 1% to about 10% (w/v) of the composition as a liquid.

19. The method of claim 16, wherein the contacting comprises coating the composition onto a surface of the meat.

20. The method of claim 19, wherein a total surface of the meat is substantially coated with the composition.

21. The method of claim 16, wherein the composition is a liquid and the contacting comprises injecting the meat with the composition.

22. The method of claim 21, wherein the composition is injected in an amount of at least 1-2% v/w of the meat.

23. The method of claim 16, wherein the contacting comprises immersing the meat in the composition, wherein the composition is a liquid.

24. The method of claim 16, wherein the contacting is performed for about 5, 6, 7, 8, 9, 10, 11, 12, 13, 14, 15, 16, 17, 18, 19, 20, 21, 22, 23, 24, 25. 26, 27, 28, 29 or 30 minutes or any other time period in a range defined by any two of these values.

25. The method of claim 16, wherein the contacting is performed at 5° C., 6° C., 7° C., 8° C., 9° C., or 10° C. or any other temperature in a range defined by any two of these values.

26. The method of claim 16, wherein the contacting comprises injecting or feeding the composition to an animal before slaughter.

27. The method of claim 26, wherein an amount of the composition in a liquid form is about 1 gallon per 2 to 4 kg of meat.

28. A tenderized meat product, comprising a meat selected from lamb, beef, poultry and pork, wherein the tenderized meat product comprises a powder or a liquid composition, comprising a 1-10% w/w as a powder or a 1-10% w/v as a liquid, of at least one an organic acid including derivatives and salts thereof, or a polyphenol including derivatives and salts thereof, or both an organic acid and a polyphenol and derivatives and salts thereof, wherein the organic acid and the polyphenol are derived from natural plant or animal sources, the composition further comprising at least one additive selected from ρ-coumaric acid, Tyrosol, hydroxytyrosol, vanillic acid, siringic acid, caffeic acid, ferulic acid, sinapic acid, cinnamic acid, dihydroferulic acid, oleuropein, ellagic acid, glansrin, tannic acid, and taxifolin.
